(19) United States
(12) Patent Application Publication
(10) Pub. No.: US 2025/0270774 A1
(43) Pub. Date: Aug. 28, 2025

(54) CONSTRUCTION MACHINE

(71) Applicant: Caterpillar Paving Products Inc, Brooklyn Park, MN (US)

(72) Inventors: Eric S. Engelmann, Delano, MN (US); Gianfranco Perri, Bologna (IT); Dario Sansone, Bologna (IT); Conwell K Rife, JR., Hannover (PA)

(73) Assignee: Caterpillar Paving Products Inc., Brooklyn Park, MN (US)

(21) Appl. No.: 19/097,184

(22) Filed: Apr. 1, 2025

(51) Int. Cl. E01C 23/088; E01C 19/48; E01C 23/06

(52) U.S. Cl. CPC E01C 23/088; E01C 19/48; E01C 23/065; E01C 2301/00

(57) ABSTRACT

A construction machine is disclosed. The construction machine comprises a frame. The construction machine further comprises one or more ground-engaging tools coupled to the frame and configured to perform operations of the construction machine. The construction machine further comprises a plurality of propulsion devices configured to propel the construction machine on a work surface. The construction machine further comprises one or more non-combustible power sources configured to power at least one of the one or more ground-engaging tools and the plurality of propulsion devices. The one or more non-combustible power sources are positioned on the frame based on a desired distribution of weight across the construction machine.

### TECHNICAL FIELD

The present disclosure relates to a construction machine, and more particularly, to a hydrogen or electric-powered construction machine such as a cold planer/paving machine.

### BACKGROUND

Work machines, such as cold planers, road reclaimers, pavement profilers, roadway planers, rotary mixers, and the like, are designed for scarifying, removing, mixing, or reclaiming material from a ground surface. Such machines typically have a rotor that may be mechanically coupled to a power source to drive the rotor. Currently, the work machines may employ an internal combustion engine to power the rotor of the cold planer. The internal combustion engine may cause noise and air pollution through emissions caused by a combustion process. Further, the internal combustion engine may have packaging constraints on the work machine due to a placement of the internal combustion engine. Therefore, the internal combustion engine may be mounted on the side where the rotor is placed. The placement of the power source (internal combustion engine) may transfer an overall weight distribution of the work machine to one side of the work machine.

U.S. Patent Publication No. 2022/0395938 relates to a milling machine having a power source that generates an output power for performing one or more work operations. The milling machine also includes a rotor that receives a portion of the output power from the power source for operation thereof. The milling machine further includes a welding device disposed on the milling machine for servicing one or more machine components of the milling machine. The welding device is powered by the power source.

### SUMMARY OF THE INVENTION

In one aspect, the disclosure relates to a construction machine. The construction machine comprises a frame. The construction machine further comprises one or more ground-engaging tools coupled to the frame and configured to perform operations of the construction machine. The construction machine further comprises a plurality of propulsion devices configured to propel the construction machine on a work surface. The construction machine further comprises one or more non-combustible power sources configured to power at least one of the one or more ground-engaging tools and the plurality of propulsion devices. The one or more non-combustible power sources are positioned on the frame based on a desired distribution of weight across the construction machine.

### BRIEF DESCRIPTION OF THE DRAWINGS

FIG. 1 is a side view of an exemplary construction machine including a non-combustible power source, in accordance with an embodiment of the present disclosure;

FIG. 2 is a side view of an exemplary construction machine including a non-combustible power source, in accordance with another embodiment of the present disclosure;

FIG. 3 is a side view of an exemplary construction machine including a non-combustible power source, in accordance with yet another embodiment of the present disclosure;

FIG. 4 is a side view of an exemplary construction machine including a non-combustible power source, in accordance with yet another embodiment of the present disclosure; and

FIG. 5 is a side view of an exemplary construction machine including a non-combustible power source, in accordance with yet another embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

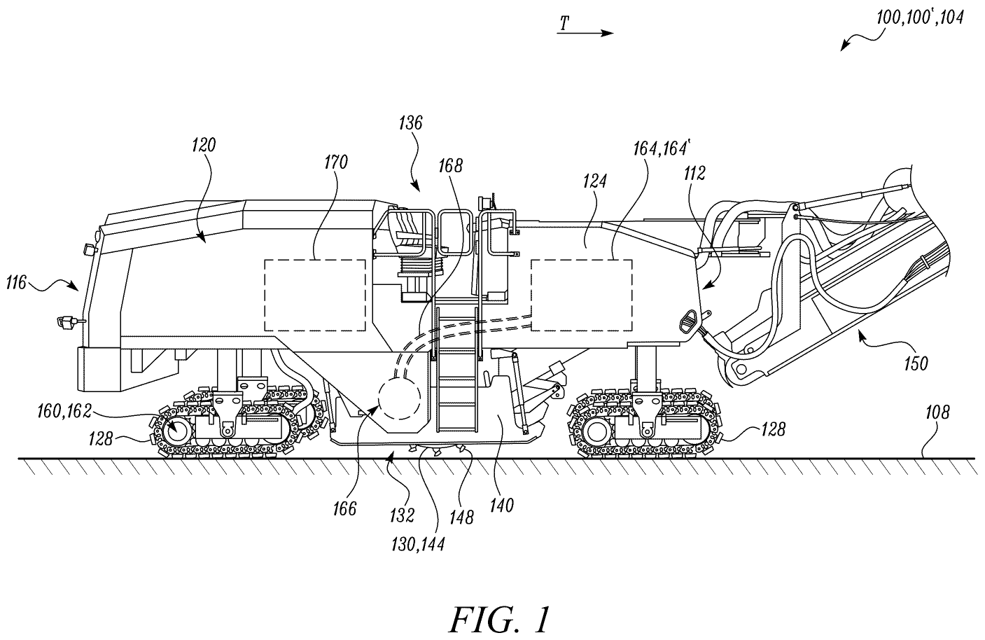

Referring to FIG. 1, an exemplary construction machine 100 is shown. The construction machine 100 may include a milling machine 100′. As an example, the milling machine 100′ may include a cold planer 104. The construction machine 100 may be used to perform a milling operation to modify a work surface 108. For example, the milling operation may mean or include scarifying, removing, mixing, and/or reclaiming material, from the work surface 108 for the laying of a new surface. Although references to the milling machine 100′ are used, aspects of the present disclosure may also be applicable to other machines, e.g., to mobile machines, such as excavators, loaders, graders, off highway trucks, and the like, and references to the milling machine 100′ in the present disclosure is to be viewed as purely exemplary.

The construction machine 100 may define a front end 112 and a rear end 116 opposite to the front end 112. The front end 112 and the rear end 116 may be defined in relation to an exemplary direction of travel (indicated by an arrow ‘T’) of the construction machine 100, with said direction of travel being defined from the rear end 116 towards the front end 112. Also, the construction machine 100 may include two lateral sides, i.e., a first lateral side 120 (or left side) and a second lateral side (or right side) (not shown) opposite to the first lateral side 120. The two lateral sides may be located transversely relative to the exemplary direction of travel ‘T’ of the construction machine 100. Further, the construction machine 100 may include a frame 124, a set of traction devices 128, one or more ground engaging tools 130, a milling assembly 132, and an operator station 136.

The traction devices 128 may support and propel the frame 124 (or the construction machine 100) over the work surface 108. Exemplarily, the construction machine 100 may include four traction devices 128 (one at each corner of the frame 124), although lesser or higher number of traction devices 128 may be contemplated. The construction machine 100 may further include the ground engaging tool 130 coupled to the frame 124. The ground engaging tool 130 may be configured to contact the work surface 108 to perform an operation on the work surface 108 such as a milling operation of the construction machine 100.

The milling assembly 132 may be supported by the frame 124 and may be configured to facilitate the milling operation. The milling assembly 132 may include a mixing chamber 140 and a rotor 144 (e.g., ground engaging tool 130) disposed within the mixing chamber 140. The rotor 144 may include cutting elements 148 arranged around its periphery to engage, grind, and/or pulverize the work surface 108, as the construction machine 100 moves over the work surface 108 (e.g., along the direction, T). Milled materials resulting from the milling operation may be transferred to a conveyor 150, which may in turn convey the milled materials into a dump body of a transport vehicle (e.g., a dump truck) (not shown) that may move ahead of the construction machine 100.

The operator station 136 may be supported over the frame 124. The operator station 136 may facilitate stationing of one or more operators therein, to monitor the operations of the construction machine 100. Also, the operator station 136 may house various components and controls of the construction machine 100, access to one or more of which may help the operators to control the machine's movement and/or operation. For instance, the operator station 136 may include an input device (not shown) that may be used and/or actuated to generate an input for facilitating control of various systems or devices associated with the construction machine 100.

With continued reference to FIG. 1, the construction machine 100 may include a propulsion system 160. The propulsion system 160 may be configured to propel the construction machine 100 on the work surface 108 (e.g., along the direction, T). For example, the propulsion system 160 may include a plurality of propulsion devices 162 configured to propel the construction machine 100 on the work surface 108. For example, the propulsion devices 162 may be configured to rotate the traction devices 128 for propelling the construction machine 100 of the work surface 108.

The construction machine 100 may further include one or more power sources 164. The power source 164 is configured to power at least one of the one or more ground engaging tools 130 and the plurality of propulsion devices 162. For example, the power source 164 may provide power to the propulsion devices 162 for rotating the traction devices 128 to propel the construction machine 100. The power source 164 may also provide power to the ground engaging tools 130 such as the rotor 144 to perform cutting operation of the construction machine 100.

The power source 164 may be a non-combustible power source 164′ such as an electric power source, a hydrogen fuel cell, a motor (e.g., driven by electricity, wind, waves, a fluid current, etc.), or any other type of non-combustion source of power. In an example, the non-combustible power source 164′ may provide power to a motor 166 which may be configured to rotate the rotor 144 for performing cutting operation of the construction machine 100. In another example, the non-combustible power source 164′ may provide power to the motor 166 via one or more power cables 168 coupled to the power source 164 and the motor 166. In an example, the motor 166 may be an electric motor and the like.

The power source 164 is positioned on the frame 124 based on a desired distribution of weight across the construction machine 100. For example, the power source 164 may be positioned towards the front end 112 of the construction machine 100 if the weight of the construction machine 100 is less toward the front end 112 than the rear end 116. For instance, the power source 164 may be positioned proximal to the front end 112 and distal from the rear end 116. Accordingly, if the desired weight distribution of the construction machine 100 is achieved by positioning the power source 164 at the rear end 116, the power source 164 may be positioned towards the rear end 116.

The construction machine 100 may further include a reservoir 170 positioned on the frame 126 of the construction machine 100. The reservoir 170 may be configured to store fluid (e.g., a hydraulic fluid such as water). The reservoir 170 may also be positioned on the frame 124 based on the desired distribution of weight across the construction machine 100. For example, the reservoir 170 may be positioned towards the rear end 116 of the construction machine 100 if the weight of the construction machine 100 is less towards the second end 116 than the front end 112.

The fluid may be supplied/sprayed (e.g., by way of a pump, not shown) from the reservoir 170 into the mixing chamber 140 of the milling assembly 132 and generally onto portions of the rotor 144 and the cutting elements 148 so as to dissipate heat of operation from the rotor 144 and the cutting elements 148. Additionally, or optionally, such fluid supply may also be used to suppress and settle a volume of dust arising from the work surface 108 as the cutting elements 148 may engage the work surface 108 to perform the milling operation.

It will be appreciated that the reservoir 170 of the construction machine 100, may require to be regularly replenished with the water as a low or no fluid level of the fluid may result in an insufficient supply of fluid to the rotor 144 and the cutting elements 148, potentially resulting in improper heat dissipation, reduced suppression of dust, and potential component failure. Therefore, as the reservoir 170 may be replenished or as fluid may be introduced (through any suitable method) into the reservoir 170, a fluid level of the fluid may increase within the reservoir 170.

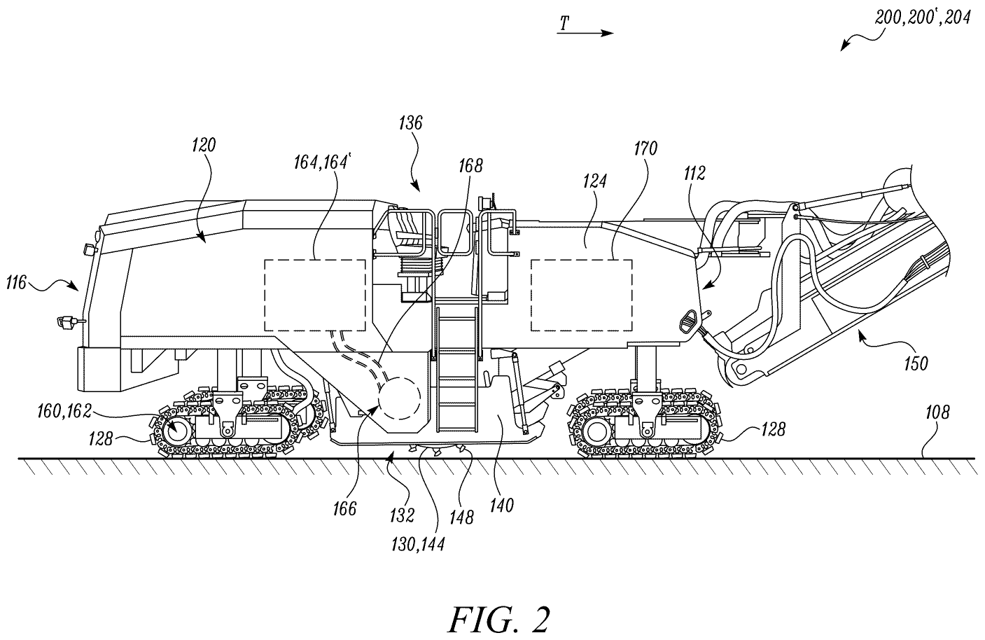

Referring now to FIG. 2, a construction machine 200 is shown. The construction machine 200 may include a milling machine 200′. The construction machine 200 may be similar in all respects to the construction machine 100 but may differ from the construction machine 100 with respect to the positioning of the power source 164 and the reservoir 170 on the construction machine 200. The power source 164 may be positioned towards the rear end 116 of the construction machine 200. For example, the power source 164 may be positioned proximal to the rear end 116 and distal from the front end 112. The reservoir 170 may be positioned towards the front end 112 of the construction machine 200. For example, the reservoir 170 may be positioned proximal to the front end 112 and distal from the rear end 116. The position of the power source 164 and the reservoir 170 may be decided based on the desired weight distribution of the construction machine 200.

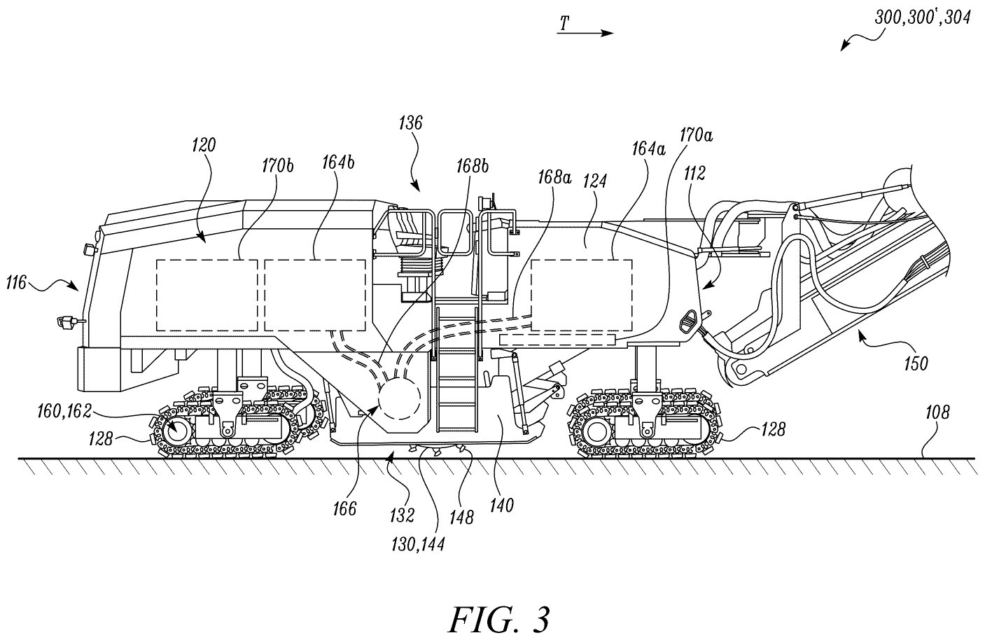

Referring now to FIG. 3, a construction machine 300 is shown. The construction machine 300 may include a milling machine 300. The construction machine 300 may be similar in all respects to the construction machine 100 but may differ from the construction machine 100 with respect to the positioning of the power source 164 and the reservoir 170 on the construction machine 300. The construction machine 300 may include a first power source 164a and a second power source 164b. The first power source 164a may be positioned towards the front end 112 of the construction machine 300 and the second power source 164b may be positioned towards the rear end 116 of the construction machine 300.

The first power source 164a may be configured to transfer power to the electric motor 166 via a first set of power cables 168a. Similarly, the second power source 164b may be configured to transfer power to the electric motor 166 via a second set of power cables 168b. Further, the construction machine 300 may include a first reservoir 170a and a second reservoir 170b. The first reservoir 170a may be positioned towards the front end 112 of the construction machine 300 and the second reservoir 170b may be positioned towards the rear end 116 of the construction machine 300. The position of the first power source 164a, the second power source 164b, the first reservoir 170a, and the second reservoir 170b may be decided based on the desired weight distribution of the construction machine 300.

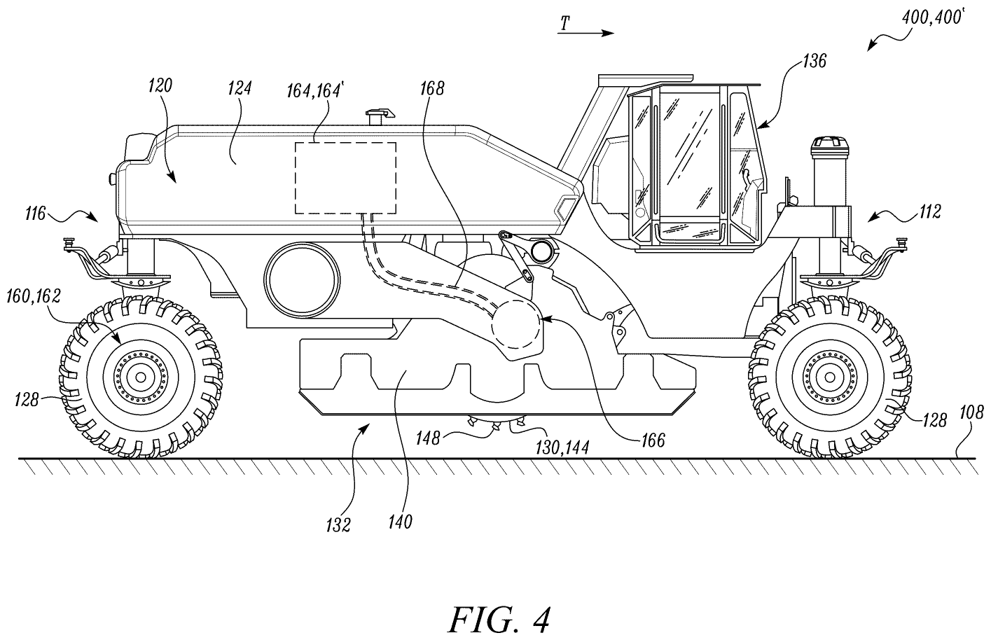

Referring now to FIG. 4, a construction machine 400 is shown. The construction machine 400 may include a rotary mixer 400. The construction machine 400 may be similar to the construction machine 100 but may differ from the construction machine 100 in that the construction machine 400 may eliminate a requirement of any reservoir. The construction machine 400 may also differ from the construction machine 100 with respect to the positioning of the power source 164. The power source 164 may be positioned towards the rear end 116. For example, the power source 164 may be positioned proximal to the rear end 116 and distal from the front end 112. The position of the power source 164 may be decided based on the desired weight distribution of the construction machine 400. For instance, the power source 164 may be placed towards the rear end 116 to balance a weight of the operator station 136 which is positioned towards the front end 112 of the construction machine 400.

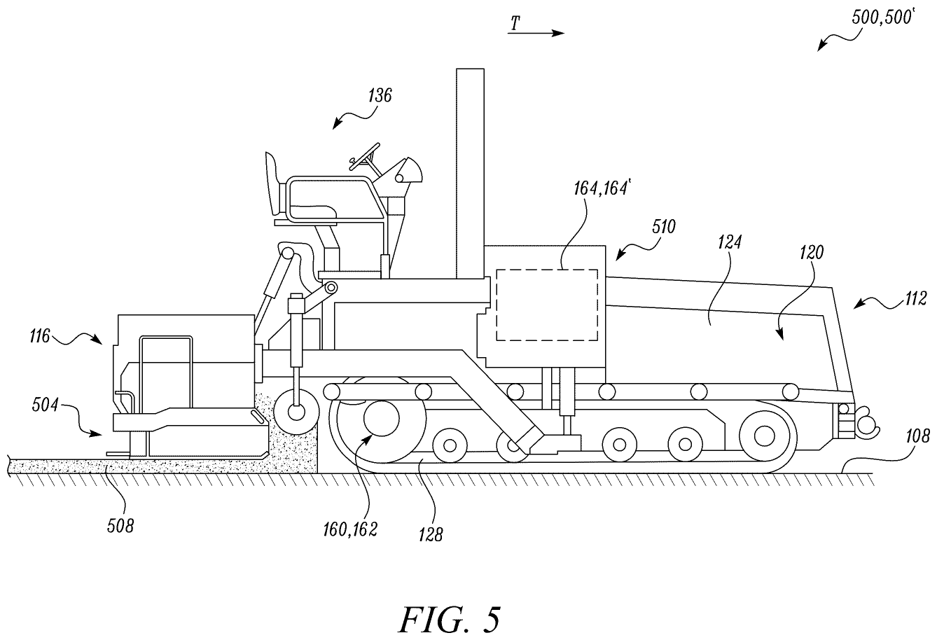

Referring now to FIG. 5, a construction machine 500 is shown. The construction machine 500 may include an asphalt paver 500′. The construction machine 500 may be similar to the construction machine 100 but may differ from the construction machine 100 in that the construction machine 500 may eliminate a requirement of the milling assembly 132 and any reservoir. The construction machine 500 may include a screed and auger assembly 504 attached at the rear end 116 of the construction machine 500. The screed and auger assembly 504 may be configured to spread and compact paving material into a paving or mat 508 having a desired thickness, size, uniformity, crown profile and cross slope.

The power source 164 may be configured to provide power to the screed and auger assembly 504 to spread and compact the paving material. The power source 164 may be positioned at a center portion 510 of the construction machine 500. The position of the power source 164 may be decided based on the desired weight distribution of the construction machine 500. For instance, the power source 164 may be placed towards the center portion 510 to balance a weight of the screed and auger assembly 504 which is positioned towards the rear end 116 of the construction machine 500.

### INDUSTRIAL APPLICABILITY

The construction machine 100 including the non-combustible power source 164′ may be configured to eliminate the use of larger mechanical drivelines which was used to transfer the power from a conventional power source (e.g., an internal combustion engine) to the ground engaging tools 130 such as the rotor 144. The use of non-combustible power source 164′ without the larger mechanical drivelines may facilitate potential flush cut on both sides of the construction machine 100 (e.g., milling machine 100′) rather than conventional one side flush cut due to the positioning of the drivelines coupled to the internal combustion engine and the ground engaging tools 130.

The elimination of such drivelines may also allow the power source 164 to be positioned in non-traditional locations/orientations within the construction machine 100, thereby providing the desired weight distribution of the construction machine 100. The positioning of the non-combustible power source 164′ on the construction machine 100 may allow elimination of counterweights that may be used to achieve the desired weight distribution of the construction machine 100 due to position constraints of the conventional power source on the construction machine 100.

The use of non-combustible power source 164′ thus allows flexibility in positioning of one or more components of the construction machine 100 depending on the requirement of the construction machine 100. For example, the non-combustible power source 164′ may be positioned towards the front end 112 of the construction machine 100 and the reservoir 170 may be positioned towards the rear end 116 of the construction machine 100 (see FIG. 1). This configuration of the construction machine 100 may facilitate refilling of the reservoir 170 as the refilling is typically done from the rear end 116 of the construction machine 100.

The flexibility in positioning of the one or more components of the construction machine 100 may also help to reduce an overall size of the construction machine 100 and may also help in increasing operator visibility. Furthermore, the use of non-combustible power source 164′ also eliminates carbon emissions that are caused by the combustible power source such as, but not limited to the internal combustion engine. The use of non-combustible power source 164 also helps in reducing sounds levels of the operation of the construction machine 100. For example, the noise generated by the cutting process, propelling, and conveying of material during the milling machine 100′ may be reduced.

It will be apparent to those skilled in the art that various modifications and variations can be made to the system and/or method of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A construction machine comprising:
a frame;
one or more ground-engaging tools coupled to the frame and configured to perform operations of the construction machine;
a plurality of propulsion devices configured to propel the construction machine on a work surface; and
one or more non-combustible power sources configured to power at least one of the one or more ground-engaging tools and the plurality of propulsion devices,
wherein the one or more non-combustible power sources are positioned on the frame based on a desired distribution of weight across the construction machine.
